(19) United States
(12) Patent Application Publication
(10) Pub. No.: US 2018/0062432 A1
(43) Pub. Date: Mar. 1, 2018

(54) POWER RECEIVING ANTENNA AND WEARABLE ELECTRONIC DEVICE WITH THE SAME

(71) Applicant: Silergy Semiconductor Technology (Hangzhou) LTD, Hangzhou (CN)

(72) Inventors: Chen Zhao, Hangzhou (CN); Wang Zhang, Hangzhou (CN)

(21) Appl. No.: 15/674,174

(22) Filed: Aug. 10, 2017

(30) Foreign Application Priority Data
Aug. 31, 2016 (CN) 201610798778.0

(51) Int. Cl. H02J 50/10; H01Q 7/00; H01Q 1/27; H01Q 1/22

(52) U.S. Cl. CPC H02J 50/10; H01Q 7/00; G06F 1/163; H01Q 1/2258; H01Q 1/273

(57) ABSTRACT

A power receiving device of a contactless power supply configured in a wearable electronic device having a main body coupled to a wearing member, can include: a power receiving antenna including a receiving coil; a conducting wire of the receiving coil that substantially extends along a plane in which the wearing member and the main body are disposed; where the receiving coil is formed when the wearing member is coupled with the main body as a ring shape; and where an axial direction of the receiving coil passes through the ring shape.

### RELATED APPLICATIONS

This application claims the benefit of Chinese Patent Application No. 201610798778.0, filed on Aug. 31, 2016, which is incorporated herein by reference in its entirety.

### FIELD OF THE INVENTION

The present invention generally relates to the field of contactless power supplies, and more particularly to power receiving antennas and associated wearable electronic devices.

### BACKGROUND

Contactless power supply techniques are becoming widely used in electronic products, such as mobile phones, MP3 players, digital cameras, laptops, and so on. In one resonance-type contactless power supply approach, a coupling circuit can include a power transmitting antenna and a power receiving antenna. The power transmitting antenna and other components in a power transmitter may form a transmitter-side resonant circuit, and the power receiving antenna and other components in a power receiver may form a receiver-side resonant circuit. Electric energy can be transferred in a contactless manner when the transmitter-side resonant circuit and the receiver-side resonant circuit have the same resonance frequency. The receiver-side resonant circuit can be coupled to the transmitter-side resonant circuit via electromagnetic field, and may thus resonate when the transmitter-side resonant circuit resonates.

### BRIEF DESCRIPTION OF THE DRAWINGS

FIG. 1A is a diagram of an example power receiving antenna.

FIG. 1B is a diagram of an example wearable electronic device and a power transmitter.

FIG. 2A is a diagram of an example power receiving antenna, in accordance with embodiments of the present invention.

FIG. 2B is a diagram of an example contactless power receiving circuit, in accordance with embodiments of the present invention.

FIG. 2C is an equivalent diagram of an example wearable electronic device and a power transmitting antenna, in accordance with embodiments of the present invention.

FIG. 3A is a diagram of an example wearable electronic device coupling with a power transmitter, in accordance with embodiments of the present invention.

FIG. 3B is a diagram of an example transmitting coil of a power transmitting antenna of FIG. 3A, in accordance with embodiments of the present invention.

FIG. 4 is a diagram of another example wearable electronic device coupling with a power transmitter, in accordance with embodiments of the present invention.

FIG. 5A is a diagram of yet another example wearable electronic device coupling with a power transmitter, in accordance with embodiments of the present invention.

FIG. 5B is a diagram of an example transmitting coil of a power transmitting antenna in FIG. 5A, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

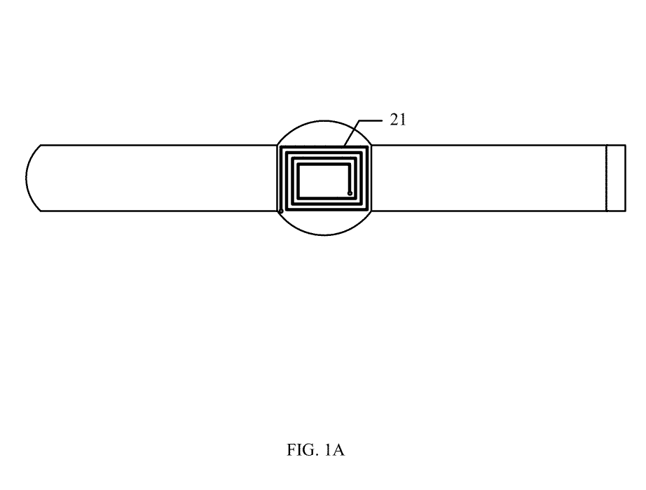

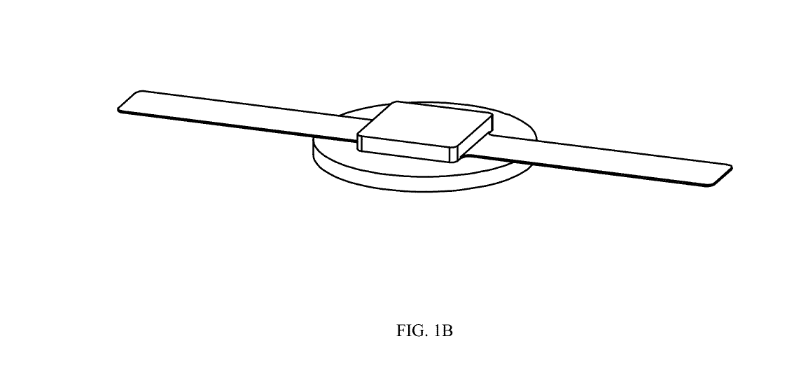

Contactless power supply techniques or wireless charging techniques have good applicable in wearable electronic devices. Referring now to FIG. 1A, shown is a diagram of an example power receiving antenna. Also referring to FIG. 1B, shown is a diagram of an example wearable electronic device and a power transmitter. In a wearable electronic device, such as a smart watch, a power receiving antenna may typically only be disposed on the main body (e.g., dial) of the wearable device. Because the main body of the wearable electronic device normally has a relatively small volume, the coil area of the power receiving antenna will be limited to the area of the set surface. Such an arrangement may not be conducive to the transmission of wireless power, and may result in lower system efficiency.

In the examples herein, a smart watch is generally described; however, those skilled in the art will recognize that certain embodiments are not limited to smart watches, but can include any other wearable electronic devices with a wearing member (e.g., a Bluetooth earphone, a smart headband, a smart glasses, etc.). In one embodiment, a power receiving device of a contactless power supply configured in a wearable electronic device having a main body coupled to a wearing member, can include: (i) a power receiving antenna including a receiving coil; (ii) a conducting wire of the receiving coil that substantially extends along a plane in which the wearing member and the main body are disposed; (iii) where the receiving coil is formed when the wearing member is coupled with the main body as a ring shape; and (iv) where an axial direction of the receiving coil passes through the ring shape.

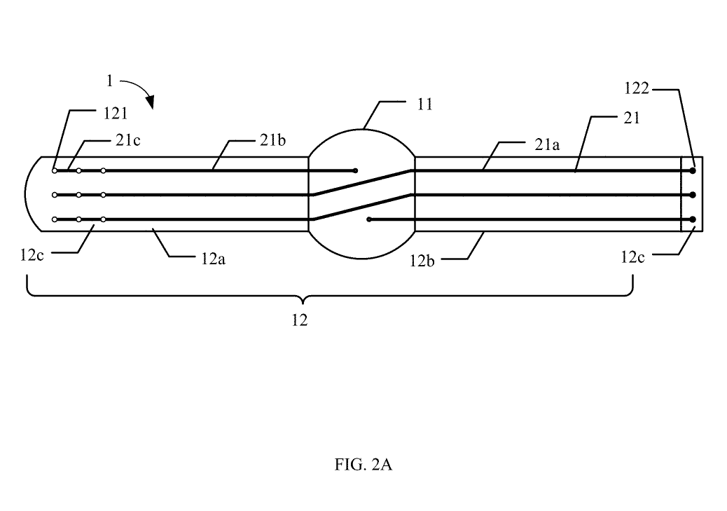

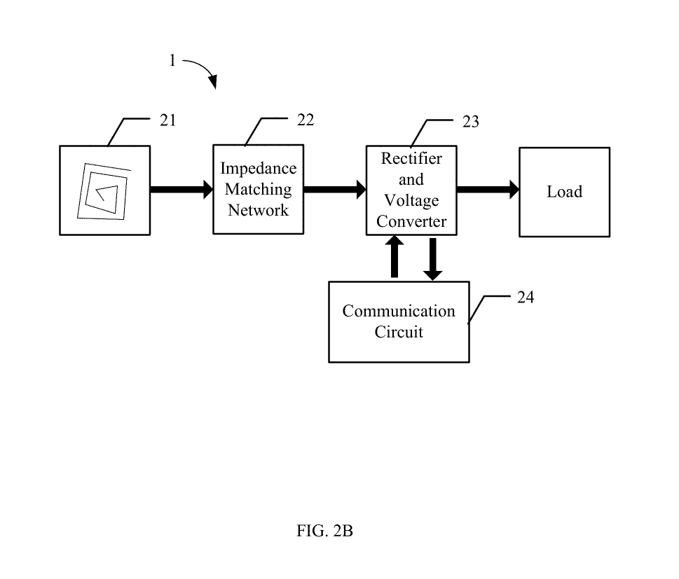

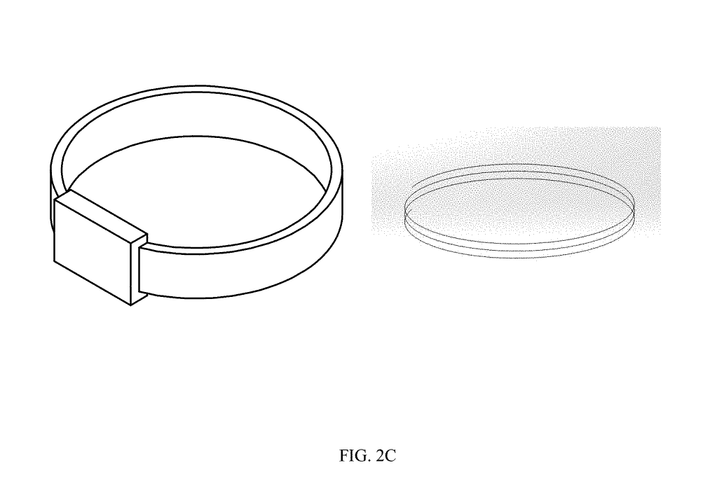

Referring now to FIG. 2A, shown is a diagram of an example power receiving antenna, in accordance with embodiments of the present invention. In this particular example, smart watch 1 provided with a power receiving antenna can include main body 11 and watchband 12. For example, main body 11 is an entity for performing the functions of the smart watch. Main body 11 can include a watchcase, a display device located inside the watchcase or integrated with the watchcase, a human-computer interaction device, a processing circuit, a power supply, etc.. In order to receive the wireless power supply, main body 11 also can include contactless power receiving circuit 2. Contactless power receiving circuit 2 can receive power from a power transmitter in a contactless or wireless manner.

Referring now to FIG. 2B, shown is a diagram of an example contactless power receiving circuit, in accordance with embodiments of the present invention. In this particular example, contactless power receiving circuit 2 can include power receiving antenna 21, impedance matching network 22, and rectifier and voltage converter 23. Contactless power receiving circuit 2 can further include communication circuit 24 for communicating with the power transmitter when necessary. Watchband 12 is used to wear main body 11 on a human body, for example, wear on the wrist of a human.

Referring also to FIG. 2A, watchband 12 can include two portions 12a and 12b that are mechanically coupled to main body 11. The two portions 12a and 12b can be coupled with each other through connection portion 12c, such that the smart watch is in the form of a ring, and may fixedly attach on a human's arm. Watchband 12 may only include one portion with one terminal coupled to main body 11 in a fixed manner, and the other terminal coupled to the other side of main body 11 in a detachable manner. In this example, watchband 12 is the wearing member of the wearable electronic device. When the wearable electronic device is a smart ring, a smart headband, or a smart glass, the wearing member may fix the main body of the wearable electronic device as essentially a subsidiary structure of the human body, and may be suitable to form a ring shape together with the main body.

As shown in FIG. 2A, power receiving antenna 21 can include at least one receiving coil. A portion of the receiving coil may be disposed on watchband 12, and another portion may be disposed on main body 11. The conducting wire of the receiving coil can substantially extend along the plane in which watchband 12 and main body 11 are disposed. For example, conducting wire of the receiving coil may substantially extend along the length direction of watchband 12, until reaching connection portion 12c that can couple together the different portions of the watchband.

Referring now to FIG. 2C, shown is an equivalent diagram of an example wearable electronic device and a power transmitting antenna, in accordance with embodiments of the present invention. In this particular example, when watchband 12 and main body 11 are coupled as a ring shape, the conducting wire that extends along watchband 12 and main body 11 may form the receiving coil. In addition, the axial direction of the receiving coil can pass through the center of the ring shape. Thus, the receiving coil and the ring shape of smart watch 1 can be co-axial. The area (axial cross-sectional area) of the receiving coil may be substantially equal to the area of the ring shape, which may be far larger than the configuration of disposing the receiving coil on watchband 12 or main body 11. This arrangement can provide a greater degree of freedom for the system design, and accordingly improve power transmission efficiency.

As shown in FIG. 2A, each of the receiving coils can include portion 21a disposed on watchband 12a, portion 21b disposed on wearing portion 12b, and portion 21c that extends to connection portion 12c. Connection portion 12c can be made of a conductive material, and used to mechanically couple watchband 12a and wearing portion 12b. Connection portion 12c can electrically couple the conducting wires of portions 21a and 21b of the receiving coil through portion 21c and connection portion 12c, in order to form the receiving coil. The leading end of the receiving coil can extend to main body 11, in order to couple with the circuitry inside main body 11.

Connection portion 12c can include conductive connectors 121 and 122. Connectors 121 can be insulated from each other, and connectors 122 can be insulated from each other. Thus, the conducting wires in different turns may not be electrically coupled at connection portion 12c. Connectors 121 and corresponding connectors 122 can be coupled in an interconnection manner, in order to couple different portions 12a and 12b of the watchband. Because connectors 121 and 122 are all conductive, the electrical connection can be set up when connectors 121 are mechanically coupled to connectors 122.

The interconnection between connectors 121 and 122 can make the different portions of watchband 12 integrally connected. Thus, the conducting wires that extend on the different portions of watchband 12 can be electrically coupled to form the receiving coil approximately in a spiral shape. For example, connectors 121 can be metal holes, and connectors 122 can be metal needles adapted to be inserted into the metal holes. In another alternative example, connectors 121 and 122 can be adapted to each other in a metal snap structure. In yet another example, connectors 121 and 122 can be magnet and metal bumps that can be attracted to each other.

For example, as shown in FIG. 2A, in order to facilitate the length regulation of watchband 12, connectors 121, and/or connectors 122 can include a plurality of optional connection locations, and may be adapted to couple with corresponding connectors 122 or connectors 121 at different locations. Thus, power reception may not be affected when regulating the length of the watchband. One terminal of watchband 12 can be coupled to the main body 11 in a fixed manner, and another terminal may be coupled to main body 11 in a detachable manner. The conducting wire of the receiving coil can include a portion that extends to connection portion 12c. Connection portion 12c can be made of a conductive material, and used to mechanically couple the wearing portion and the main body, as well as to electrically couple the conducting wires of the wearing portion and the main body, in order to form the receiving coil.

For example, connection portion 12c can include conductive connectors 121 and 122. Connectors 121 can be coupled to the conducting wire of the receiving coil disposed on the wearing portion. Connectors 122 can correspond to connectors 121 one by one, and can be coupled to the conducting wire of the receiving coil disposed on the main body, in order to couple with corresponding connectors 121 in an interconnection manner. Connectors 121 may be insulated from each other, and connectors 122 may be insulated from each other. Thus, when connectors 121 and corresponding connectors 122 are mechanically coupled, the conducting wires of the receiving coil can be electrically coupled to each other, such that the conducting wires extending on the different portions of watchband 12 may form the receiving coil in an approximately spiral shape. In this way, the power receiving antenna disposed as such may provide a greater degree of freedom for the design of the power transmitter.

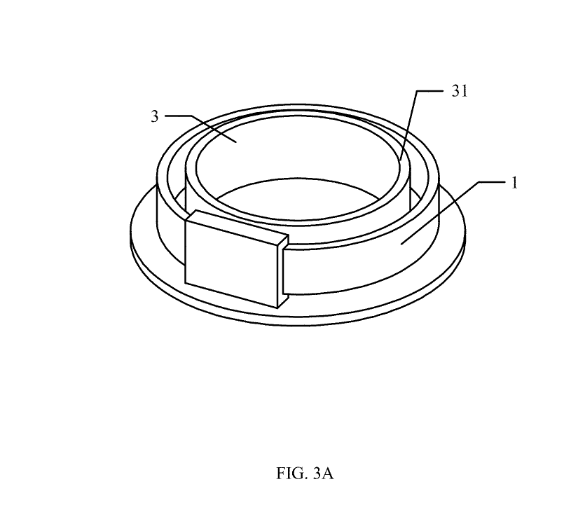

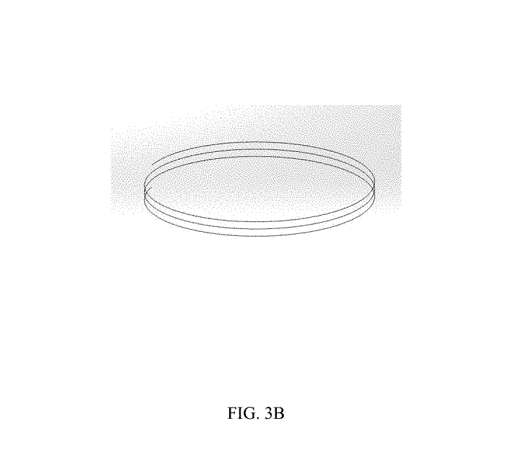

Referring now to FIG. 3A, shown is a diagram of an example wearable electronic device coupling with a power transmitter, in accordance with embodiments of the present invention. The coil of the power receiving antenna and the coil of the pow will er transmitting antenna may share a coaxial center axis. In this particular example, two portions of watchband 12 can be coupled together as a ring shape, and be nested outside power transmitter 3 of a cylinder shape. Power transmitting antenna 31 of power transmitter 3 can cover the entire side of the cylinder shape.

Referring now to FIG. 3B, shown is a diagram of an example transmitting coil of a power transmitting antenna of FIG. 3A, in accordance with embodiments of the present invention. In this particular example, the power transmitting antenna may coincide with the axial direction of power receiving antenna 21 in the axial direction of the cylinder, in order to obtain a better degree of coupling. For example, the transmitting coil can be in a spiral shape similar to the receiving coil. In this way, no matter which direction smart watch 1 is oriented, the same power receiving effect can be achieved, and the positional degree of freedom of the power receiver can accordingly be improved.

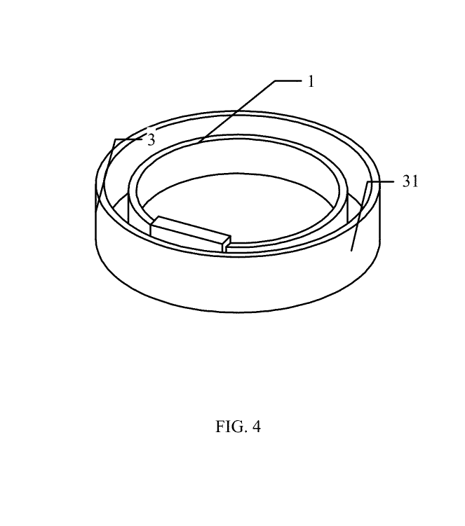

Referring now to FIG. 4, shown is a diagram of another example wearable electronic device coupling with a power transmitter, in accordance with embodiments of the present invention. In this particular example, power transmitting antenna 31 of the power transmitter may be disposed on the side of the cylinder. Here, the smart watch with two portions of the watchband coupled as a cyclic form may be placed inside the cylinder. Similarly, when the transmitting antenna covers the sides of the entire main body, no matter which direction smart watch 1 is oriented, the same power receiving effect can be achieved.

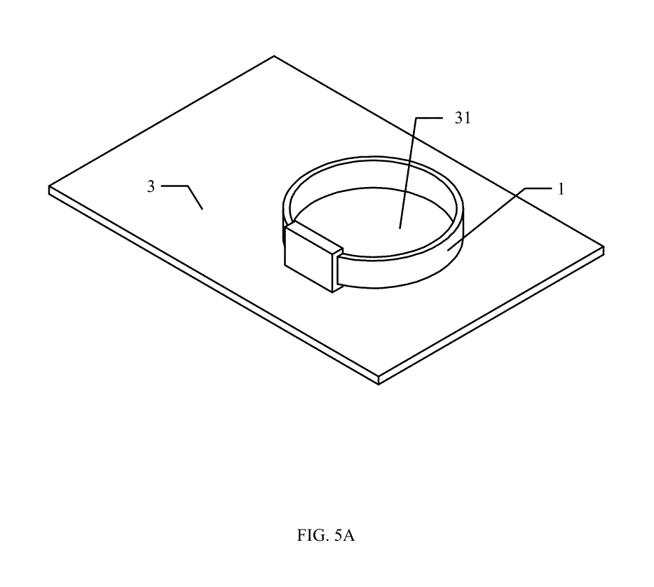

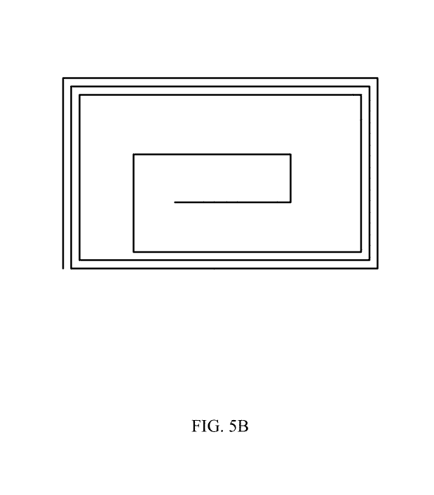

Referring now to FIG. 5A, shown is a diagram of yet another example wearable electronic device coupling with a power transmitter, in accordance with embodiments of the present invention. In this particular example, the power transmitting antenna of power transmitter 3 may be provided as an ordinary planar shape.

Referring now to FIG. 5B, shown is a diagram of an example transmitting coil of a power transmitting antenna in FIG. 5A, in accordance with embodiments of the present invention. In this particular example, the transmitting coil can be at least one concentric turn that substantially extends along the plane. The axis of the transmitting coil can be perpendicular to the plane in which the transmitting coil is located, and the smart watch coupled in a ring shape may be placed on the plane. The axis of the receiving coil of the power receiving antenna can pass through the ring shape. Therefore, the receiving coil and the transmitting coil may be co-axial in order to obtain a better degree of coupling, and to improve the power transmission effect.

For example, watchband 11 can be at least partially made of a flexible material, such that watchband 11 can be easily coupled as a ring shape, or unfolded as a planar shape. In another example, watchband 11 or the wearing members of other wearable electronic devices can be made of substantially rigid materials, and may have a curved surface for providing the receiving antenna. In addition, the receiving coil can be formed on the surface of watchband 12 or inside the watchband, and may be integrally formed with watchband 12.

In particular embodiments the wearing member of the wearable electronic device with a relatively large area can be utilized to dispose the receiving coil on the wearing member and the main body. In this way, the receiving coil may be formed when the wearing member and the main body of the wearable electronic device are coupled as a ring shape, and the axial direction of the receiving coil can pass through the ring shape. Therefore, the axial cross-sectional area of the coil of the power receiving antenna may substantially be the area of the ring shape, and the coil area can be substantially enlarged. In this fashion, the receiving efficiency of the wireless power supply can be improved.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A power receiving device of a contactless power supply configured in a wearable electronic device having a main body coupled to a wearing member, said power receiving device comprising:
a) a power receiving antenna comprising a receiving coil;
b) a conducting wire of said receiving coil that substantially extends along a plane in which said wearing member and said main body are disposed;
c) wherein said receiving coil is formed when said wearing member is coupled with said main body as a ring shape; and
d) wherein an axial direction of said receiving coil passes through said ring shape.

2. The power receiving device of claim 1, wherein:
a) said wearing member comprises a wearing portion and a connection portion, said wearing portion having one terminal coupled to said main body, and another terminal coupled to said main body through said connection portion in a detachable manner; and
b) said conducting wire of said receiving coil comprises a portion that extends on said wearing portion and said connection portion, said connection portion is configured to mechanically couple said wearing portion with said main body, and to electrically couple conducting wires of said wearing portion and said main body, in order to form said receiving coil.

3. The power receiving device of claim 2, wherein said connection portion comprises:
a) a plurality of conductive first connectors coupled to said conducting wire of said receiving coil disposed on said wearing portion;
b) a plurality of conductive second connectors that correspond to said first connectors, are coupled said conducting wire of said receiving coil disposed on said main body, and are adapted to couple with said first connectors in an interconnection manner; and
c) said first connectors being insulated from each other, and said second connectors being insulated from each other.

4. The power receiving device of claim 1, wherein said wearing member comprises:
a) first and second wearing portions coupled through said connection portion in a detachable manner; and
b) said receiving coil comprises a first portion disposed on said first wearing portion, a second portion disposed on said second wearing portion, and a third portion that extends to said connection portion, wherein said connection portion is configured to mechanically couple said first wearing portion to said second wearing portion, and to electrically couple corresponding conducting wires disposed on said first and second wearing portions, in order to form said receiving coil.

5. The power receiving device of claim 4, wherein said connection portion comprises:
a) a plurality of conductive first connectors coupled to said conducting wire of said receiving coil that is disposed on said first wearing portion;
b) a plurality of conductive second connectors that correspond to said first connectors, are coupled said conducting wire of said receiving coil disposed on said second wearing portion, and are adapted to couple with said first connectors in an interconnection manner; and
c) said first connectors being insulated from each other, and said second connectors being insulated from each other.

6. The power receiving device of claim 3, wherein said conductive first connectors comprise a plurality of optional connection locations, and are adapted to couple with corresponding said conductive second connectors in different locations.

7. The power receiving device of claim 3, wherein said conductive second connectors comprise a plurality of optional connection locations, and are adapted to couple with corresponding said first conductive connectors in different locations.

8. The power receiving device of claim 1, wherein said wearing member comprises a flexible material.

9. The power receiving device of claim 1, wherein said receiving coil is formed on said surface of said wearing member.

10. The power receiving device of claim 1, wherein said receiving coil is formed inside said wearing member.

11. The power receiving device of claim 1, wherein said wearable electronic device is a smart watch, and said wearing member is a watchband.
